(19) United States
(12) Patent Application Publication
(10) Pub. No.: US 2009/0100528 A1
(43) Pub. Date: Apr. 16, 2009

(54) Method for Linking Intellectual Property System to Other System and the System

(76) Inventor: Ul-Ho Lee, Gyeonggi-do (KR)

Correspondence Address: HARNESS, DICKEY & PIERCE, P.L.C., P.O. BOX 8910, RESTON, VA, 20195, US

(21) Appl. No.: 11/887,429

(22) PCT Filed: Mar. 30, 2006
(86) PCT No.: PCT/KR2006/001158

§ 371 Date: Nov. 26, 2008

(30) Foreign Application Priority Data
Apr. 4, 2005 (KR) 10-2005-0027873

(51) Int. Cl. H04L 9/32

(52) U.S. Cl. 726/28

(57) ABSTRACT

Provided are a method and system for reducing user inconvenience by exchanging information between different intellectual property information systems having different servers from each other or storing the information in a storage folder of each user of one of the intellectual property information systems. The method associates at least first and second different intellectual property related systems operated by different servers from each other. The method includes the steps of: providing, by the first intellectual property information system, identification of a user of the first intellectual property information system to the second intellectual property information system; and providing, by the second intellectual property information system, searched case information or case information searched for each user of the second intellectual property information system to a storage folder of each user in the first intellectual property information system.

### TECHNICAL FIELD

The present invention relates to a method and system capable of reducing unnecessary developing and operating costs by implementing data exchange or screen association between different intellectual property information systems having different servers from each other.

### BACKGROUND ART

An applicant- or patent attorney-developed and operated intellectual property information system and a patent office or commercial patent search database exist as separate entities.

They manage different information and are operated separately to maximize their functions.

The applicant- or patent attorney-operated intellectual property information system provides detailed information including invention summaries and applications drafted by applicants or patent attorneys. However, such a system provides little or no information on published applications, prior art references cited in examination, and intellectual property rights including others patent applications and patents. Thus, it is necessary to separately access other intellectual property information systems, e.g., the patent office's intellectual property information system to obtain the information, and this makes users inconvenient.

Further, as storage folders for users and a patent office or intellectual property search systems are not associated with an applicant or patent attorney's intellectual property information system, the users cannot store all information of the different systems in their storage folders, and need to access the intellectual property related system each time they inquire any information.

### DISCLOSURE OF INVENTION

### Technical Problem

It is an object of the present invention to provide a method and system capable of resolving user inconvenience by storing information stored in different intellectual property information systems having different servers from each other in a storage folder of one of the intellectual property information systems.

### Technical Solution

Intellectual property information systems A 101, 201, and 301 and intellectual property information systems B 102, 202, and 302 of the present invention shown in FIGS. 1 to 3 are operated by different servers (i.e., server A and server B) and manage different information and have different screen structures. Preferably, the intellectual property information system A is a system operated by applicants or patent attorneys in a company or institution, and manages invention suggestion, draft patent applications, and data and files for patent applications. Intellectual property information system B is a system operated by a patent office of a country or a system for published intellectual property right search. When intellectual property information system B is a post-publication information search system, a user of intellectual property information system A can store and manage information of intellectual property information system B as well as information of intellectual property information system A in a storage folder of intellectual property information system A, and can conveniently inquire, on intellectual property information system A, the information of intellectual property information system B by utilizing location information of a page or original text in intellectual property information system B.

### BRIEF DESCRIPTION OF THE DRAWINGS

FIG. 1 illustrates different intellectual property information systems associated with each other according to a first embodiment of the present invention;

FIG. 2 illustrates different intellectual property information systems associated with each other according to a second embodiment of the present invention; and

FIG. 3 illustrates different intellectual property information systems associated with each other according to a third embodiment of the present invention.

### MODE FOR THE INVENTION

Hereinafter, exemplary embodiments of the present invention will be described in detail with reference to the accompanying drawings. For the sake of clarity and conciseness, matters related to the invention that are well known in the art will not be described.

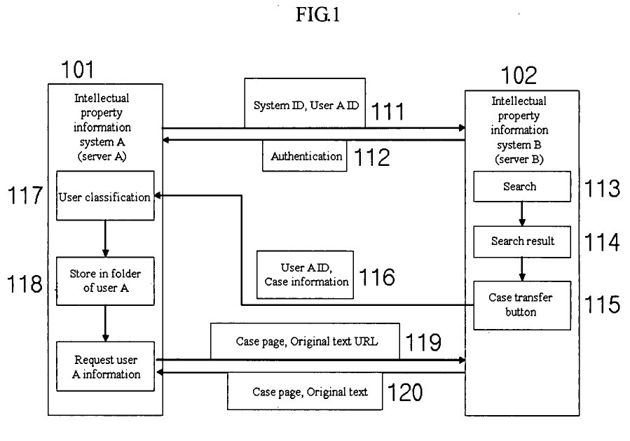

FIG. 1 illustrates different intellectual property information systems associated with each other according to a first embodiment of the present invention.

Intellectual property information system A 101 and intellectual property information system B 102 are operated by different servers (server A and server B). The intellectual property information system A 101 provides system identification (ID) of the intellectual property information system A 101 and identification of a user of the intellectual property information system A 101 to the intellectual property information system B 102 (111). The intellectual property information system B 102 authenticates the intellectual property information system A 101 based on the system identification (ID) (112).

The user transmits a result 114 of a case searched or inquired within the intellectual property information system B 102 to the intellectual property information system A 101 using a transmission means 115 of the intellectual property information system B 102.

The intellectual property information system B 102 transmits both the user identification received from the intellectual property information system A 101 and the case information to the intellectual property information system A 101 (116).

The intellectual property information system A 101 identifies the user based on the user identification received from the intellectual property information system B 102 (117), and stores the case information received from the intellectual property information system B 102 in its storage folder (118).

To inquire the case information stored in the storage folder of the user included in the intellectual property information system A 101, the user provides identification of the case or location information of the case in the intellectual property information system B 102 to the intellectual property information system B 102 (119). The intellectual property information system A 101 receives a requested screen corresponding to the case (120).

Preferably, the identification (ID) of the case is composed of a country code, a right classification, a serial number classification, a serial number, or a combination thereof.

Preferably, the requested screen is a screen including an original text or bibliographic information. When a plurality of patent cases are selected, the requested screen may be a screen displaying all the selected patent cases, including basic bibliographic information and a representative figure of each case.

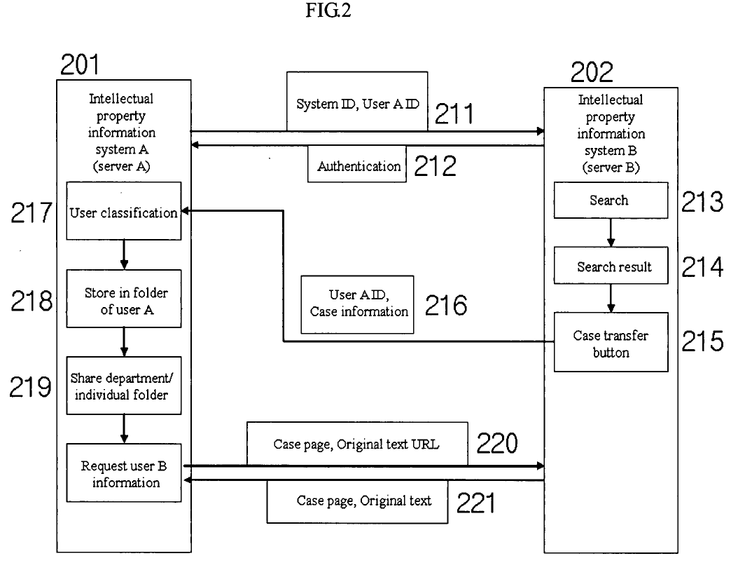

FIG. 2 illustrates different intellectual property information systems associated with each other according to a second embodiment of the present invention.

Intellectual property information system A 201 and intellectual property information system B 202 are operated by different servers (server A and server B). The intellectual property information system A 201 provides system identification (ID) of the intellectual property information system A 201 and identification of a user of the intellectual property information system A 201 to the intellectual property information system B 202 (211). The intellectual property information system B 202 authenticates the intellectual property information system A 201 based on the system identification (ID) (212).

The user transmits a result 214 of a case searched or inquired within the intellectual property information system B 201 (213) to the intellectual property information system A 201 using a transmission means 215 of the intellectual property information system B 202.

The intellectual property information system B 202 transmits both the user identification received from the intellectual property information system A 201 and the case information to the intellectual property information system A 201 (216).

The intellectual property information system A 201 identifies the user based on the user identification received from the intellectual property information system B 202 (217), and stores the case information received from the intellectual property information system B 202 in its storage folder (218).

The user may share his/her folder with other users or user groups of the intellectual property information system A 201 (219).

To inquire the case information stored in the storage folder shared by the user, the other user provides identification of the case or location information of the case in the intellectual property information system B 202 to the intellectual property information system B 202 (220). The intellectual property information system A 201 receives a requested screen corresponding to the case (221).

Preferably, the identification (ID) of the case is composed of a country code, a right classification, a serial number classification, a serial number, or a combination thereof.

Preferably, the requested screen is a screen including an original text or bibliographic information. When a plurality of patent cases are selected, the requested screen may be a screen displaying all the selected patent cases, including basic bibliographic information and a representative figure of each case.

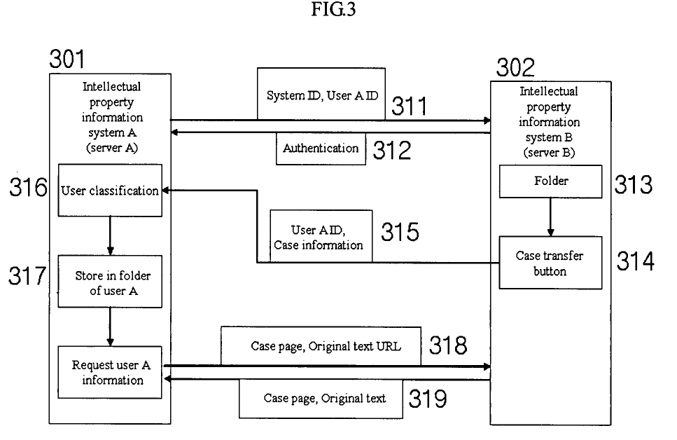

FIG. 3 illustrates different intellectual property information systems associated with each other according to a third embodiment of the present invention.

Intellectual property information system A 301 and intellectual property information system B 302 are operated by different servers (server A and server B). The intellectual property information system A 301 provides system identification (ID) of the intellectual property information system A 301 and identification of a user of the intellectual property information system A 301 to the intellectual property information system B 302 (311). The intellectual property information system B 302 authenticates the intellectual property information system A 301 based on the system identification (ID) (312).

The user selects a case to be transmitted to the intellectual property information system A 301 from cases stored in the storage folder 313 of the intellectual property information system B 302, and transmits the selected case information to the intellectual property information system A 301 using a transmission means 314 of the intellectual property information system B 302.

The intellectual property information system B 302 transmits both the user identification received from the intellectual property information system A 301 and the case information to the intellectual property information system A 301 (315).

The intellectual property information system A 301 identifies the user based on the user identification received from the intellectual property information system B 302 (316), and stores the case information received from the intellectual property information system B 302 in its storage folder (317).

To inquire the case information stored in the storage folder included in the intellectual property information system A 301, the user provides identification of the case or location information of the case in the intellectual property information system B 302 to the intellectual property information system B 302 (318). The intellectual property information system A 301 receives a requested screen corresponding to the case (319).

Preferably, the identification (ID) of the case is composed of a country code, a right classification, a serial number classification, a serial number, or a combination thereof.

Preferably, the requested screen is a screen including an original text or bibliographic information. When a plurality of patent cases are selected, the requested screen may be a screen displaying all the selected patent cases, including basic bibliographic information and a representative figure of each case.

### INDUSTRIAL APPLICABILITY

With the above system, information stored in different intellectual property information systems having different servers from each other is stored in a storage folder of one of the intellectual property information systems, thus resolving user inconvenience. In addition, prior patent applications and patents related to applicants intellectual property rights can be inquired on an applicant's system without having access to another system and performing number inquiry, thus increasing user convenience and reducing developing cost and server operating cost.

Particularly, published intellectual property information can be searched for on the applicant or patent attorney's intellectual property information system in a company and an institution through association between the applicant or patent attorney's intellectual property information system and a patent office or an intellectual property search system for providing published intellectual property rights without separately storing the published intellectual property information or separately implementing a screen for searching for an original text.

While the present invention has been described with reference to exemplary embodiments thereof, it will be understood by those skilled in the art that various changes in from and detail may be made therein without departing from the scope of the present invention as defined by the following claims.

1. A method of associating at least first and second different intellectual property related systems operated by different servers from each other, the method comprising the steps of:
providing, by the first intellectual property information system, identification of a user of the first intellectual property information system to the second intellectual property information system;
providing, by the second intellectual property information system, case information selected by a first user and identification of the first user to the first intellectual property information system; and
storing the case information selected by the first user in a storage folder of the first user of the first intellectual property information system.

2. The method of claim 1, wherein the second intellectual property information system comprises storage folders for users having a different identification from the identification of the user of the first intellectual property information system, and the selected case information in the storage folders for users of the second intellectual property information system is provided.

3. The method of claim 1, further comprising the steps of:
providing, by the first intellectual property information system, identification of the first intellectual property information system or a server of the first intellectual property information system to the second intellectual property information system; and
authenticating, by the second intellectual property information system, the first intellectual property information system or the server of the first intellectual property information system based on the identification.

4. The method of claim 1, wherein the first intellectual property information system is an intellectual property information system operated by an applicant or patent attorney.

5. The method of claim 1, wherein the second intellectual property information system is an intellectual property information system of a patent office or an intellectual property search system for providing published intellectual property information.

6. The method of claim 1, further comprising the step of sharing the storage folder of the first user of the first intellectual property information system with a second user or user group.

7. The method of claim 6, wherein the second user provides stored location information of requested information in the first intellectual property information system to the second intellectual property information system, and the second intellectual property information system provides a link to information corresponding to the location information or opens a page corresponding to the location information.

8. The method of claim 1, wherein the first user provides stored location information of requested information in the first intellectual property information system to the second intellectual property information system, and the second intellectual property information system provides a link to information corresponding to the location information or opens a page corresponding to the location information.
